(19) United States
(12) Patent Application Publication
(10) Pub. No.: US 2026/0295667 A1
(43) Pub. Date: Oct. 1, 2026

(54) MANUFACTURING METHOD OF RARE EARTH MAGNET

(71) Applicant: HONDA MOTOR CO., LTD., Tokyo (JP)

(72) Inventors: Akihito NINOMIYA, Saitama (JP); Ibuki OTA, Saitama (JP); Yasutaka SHINTANI, Saitama (JP)

(21) Appl. No.: 19/575,447

(22) Filed: Mar. 23, 2026

(30) Foreign Application Priority Data
Mar. 31, 2025 (JP) 2025-060064

(51) Int. Cl. B22F 3/14; B22F 1/142; H01F 1/053

(52) U.S. Cl. CPC B22F 3/14; B22F 1/142; H01F 1/0536; B22F 2201/10; B22F 2998/10

(57) ABSTRACT

A manufacturing method of a rare earth magnet from magnetic granular materials, each of the magnetic granular materials including laminated flake-shaped rare earth magnetic powder particles and a binder compound that binds the rare earth magnetic powder particles. The binder compound has a thermal decomposition temperature lower than the melting point of the rare earth magnetic powder particles, and is thermally decomposable at a temperature equal to or higher than the thermal decomposition temperature. The manufacturing method includes: a binder removing step of heating the magnetic granular materials to a temperature equal to or higher than the thermal decomposition temperature to thermally decompose the binder compound, thereby obtaining degreased magnetic granular materials; and a hot plastic working step of performing hot plastic working on the degreased magnetic granular materials obtained in the binder removing step to obtain the rare earth magnet.

### TECHNICAL FIELD

The present invention relates to a manufacturing method of a rare earth magnet.

### BACKGROUND ART

In recent years, efforts have been actively made to realize a low-carbon or decarbonized society, and research and development of electrification technology is being conducted for vehicles to reduce CO₂ emissions and improve energy efficiency. Methods for improving energy efficiency include improving the efficiency of motors used as power sources. In recent years, rare earth magnets have been widely used to improve motor efficiency. There is a need to improve magnetic properties of rare earth magnets. Since rare earth magnets are metallic magnets having low electrical resistivity, eddy current loss is likely to increase. Therefore, technologies for reducing eddy current loss in rare earth magnets have been proposed.

JP4784173B discloses a rare earth magnet capable of reducing eddy current losses, having rare earth magnetic powder particles, each covered with a film-like coating layer containing rare earth oxides. Bond portions containing rare earth oxide particles are interposed between the magnet powder particles coated with the rare earth oxides. A method of producing the rare earth magnet comprises conducting high-temperature pressure forming of a mixture of rare earth oxides and rare earth magnetic powder particles coated with the rare earth oxides.

JP2003-22905A discloses a manufacturing method of a rare earth magnet, comprising: mixing a magnet powder particles composed mainly of an alloy containing a Nd₂Fe₁₄B compound with one or more insulating compounds selected from oxide such as CaO, nitride such as BN, or fluoride such as CaF₂ for the purpose of increasing the electrical resistivity of the rare earth magnet; and processing the resulting mixture by hot plastic working to obtain an anisotropic magnetic material.

JP2010-27852A discloses that a first manufacturing method of a rare earth magnet comprises: preparing isotropic rapid-cooled powder particles such as Nd—Fe—B magnet powder particles; mixing the isotropic rapid-cooled powder particles with a predetermined compound for forming insulating layers; processing the mixture by cold molding to produce a cold molded product (temporary molding); processing the cold molded product by hot molding (densifying); and processing, by hot plastic molding, the resultant product (imparting anisotropy) to produce the rare earth magnet, and that a so-produced magnet includes generally stacked Nd—Fe—B rapid-cooled powder particles with the compound powder material interposed between, each particle having a long side length of 100 to 400 μm and a thickness of 20 to 40 μm.

In the rare earth magnet described in JP4784173B, an insulating material composed of dysprosium oxide (Dy₂O₃) is used as the rare earth oxide. Since dysprosium oxide has hygroscopicity, moisture adsorbed onto the dysprosium oxide may reduce the magnetic properties of the rare earth magnet. In the manufacturing method of the rare earth magnet described in JP2003-22905A, in the mixing process of mixing the Nd—Fe—B magnet powder particles with the insulating compound, the magnet powder particle is pulverized and excessively subdivided, which increases a specific surface area of the magnet powder particle and makes the magnet powder particle more susceptible to oxidation. Accordingly, oxidation of the rare earth magnet may cause a reduction in magnetic flux density of the rare earth magnet.

In the manufacturing method of the rare earth magnet described in JP2010-27852A, compound A, which is at least one compound selected from the group consisting of fluorides, oxides, and inorganic salts of heavy rare earth elements, is reacted with compound B, which is a hydride of an alkaline earth metal, during the hot forming and heat treatment step. Here, side reactions such as oxidation of the magnet, or the reaction between compound A and compound B not proceeding appropriately may result in a reduction in the magnetic properties of the manufactured rare earth magnet. Accordingly, there is a demand for a material for a rare earth magnet with reduced eddy current loss, and a rare earth magnet with reduced eddy current loss.

### SUMMARY OF THE INVENTION

In view of the above background, an object of the present invention is to provide a manufacturing method of a rare earth magnet with reduced eddy current loss, which consequently contributes to improving energy efficiency.

To achieve such an object, one aspect of the present invention provides a manufacturing method of a rare earth magnet from a plurality of magnetic granular materials, each of the plurality of magnetic granular materials including at least a plurality of laminated flake-shaped rare earth magnetic powder particles and a binder compound that binds the plurality of rare earth magnetic powder particles. The binder compound has a thermal decomposition temperature lower than the melting point of the plurality of rare earth magnetic powder particles and is thermally decomposable at a temperature equal to or higher than the thermal decomposition temperature. The manufacturing method includes: a binder removing step of heating the plurality of magnetic granular materials to a temperature equal to or higher than the thermal decomposition temperature to thermally decompose the binder compound, thereby obtaining a plurality of degreased magnetic granular materials by removing the binder compound from the plurality of magnetic granular materials; and a hot plastic working step of performing hot plastic working on the plurality of degreased magnetic granular materials obtained in the binder removing step to obtain the rare earth magnet.

According to this aspect, it is possible to provide a manufacturing method of a rare earth magnet with reduced eddy current loss.

Thus, according to the above aspects, it is possible to provide the manufacturing method for the rare earth magnet with reduced eddy current loss.

### BRIEF DESCRIPTION OF THE DRAWING(S)

FIG. 1 is a schematic cross-sectional view of a rare earth magnet according to an embodiment of the present invention;

FIG. 2 is a diagram showing a manufacturing method of the rare earth magnet according to the embodiment;

FIG. 3 is a schematic diagram of a tumbling fluidized bed apparatus;

FIG. 4A is a graph showing a difference in properties of the rare earth magnet depending on a heating method of magnetic granular materials in a binder removing step;

FIG. 4B is a graph showing a difference in properties of the rare earth magnet depending on a heating method of magnetic granular materials in a binder removing step;

FIG. 5A is a schematic diagram showing a state in which the magnetic granular materials are being heated; and

FIG. 5B is a schematic diagram showing a state in which the magnetic granular materials are being heated.

### DETAILED DESCRIPTION OF THE INVENTION

In the following, with reference to the drawings, a rare earth magnet 1 according to an embodiment of the present invention will be described in detail. In the following description, the numerical range “XX to YY” means “XX or more and YY or less” unless otherwise specified.

### Structure of the Rare Earth Magnet 1

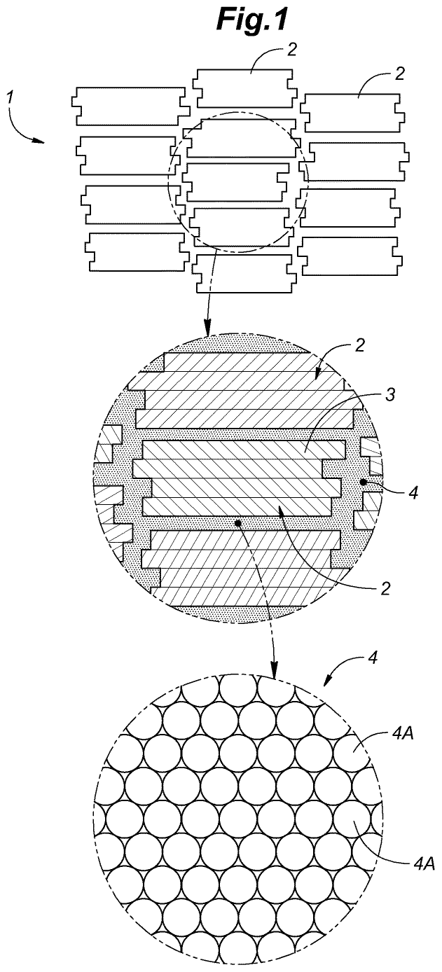

FIG. 1 is a schematic cross-sectional view of the rare earth magnet 1 according to the embodiment. As shown in FIG. 1, the rare earth magnet 1 includes a plurality of insulated magnetic granular materials 2, which may be insulated and arranged so as to be laminated. In an embodiment, each of the insulated magnetic granular materials 2 includes a plurality of laminated flake-shaped rare earth magnetic powder particles 3, and an insulating layer 4 formed on a surface layer of the insulated magnetic granular material 2 and having insulating properties. The insulating layer 4 covers an outer peripheral surface of the laminated rare earth magnetic powder particles 3.

The rare earth magnetic powder particle 3 is preferably a flake-shaped neodymium magnet (Nd—Fe—B magnet, more precisely Nd₂Fe₁₄B).

The insulating layer 4 includes the plurality of fluoride nanoparticles 4A made of a fluoride. The fluoride nanoparticles 4A are for example particles made of calcium fluoride (CaF₂). Calcium fluoride (CaF₂) has a melting point higher than that of the rare earth magnetic powder particles 3, and therefore exhibits low reactivity with the rare earth magnetic powder particles 3. The particle diameter of the fluoride nanoparticles 4A is preferably from 1 to 100 nm.

The fluoride nanoparticles 4A may be particles made of an inorganic fluorine compound having insulating properties. The fluoride nanoparticles 4A preferably have a melting point higher than that of the rare earth magnetic powder particle 3 and exhibit low reactivity with the rare earth magnetic powder particles 3. Since the fluoride nanoparticles 4A have a melting point higher than that of the rare earth magnetic powder particle 3 and exhibit low reactivity with the rare earth magnetic powder particle 3, the fluoride nanoparticles 4A are preferably nanoparticles made of an alkali metal fluoride such as lithium fluoride, or nanoparticles made of an alkaline earth metal fluoride such as magnesium fluoride, barium fluoride, or strontium fluoride. The insulating layer 4 may include, as the fluoride nanoparticles 4A, a plurality of nanoparticles made of an alkali metal fluoride and a plurality of nanoparticles made of an alkaline earth metal fluoride. The insulating layer 4 may also include, as the fluoride nanoparticles 4A, nanoparticles containing an alkali metal fluoride and an alkaline earth metal fluoride.

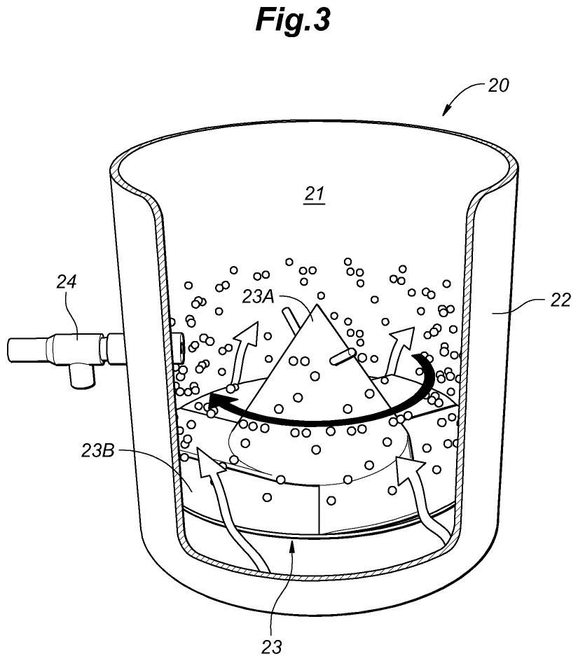

As will be described in detail later, in the manufacturing process of the rare earth magnet 1 (hot plastic working step (F) of FIG. 3), the rare earth magnetic powder particles 3 are heated, while pressure is being applied thereto in a direction (first direction) perpendicular to a main surface thereof. Accordingly, crystal grains in the magnet are shortened in the first direction (compression direction) and elongated in a direction perpendicular to the first direction (direction in which the main surface extends). The rare earth magnet 1 is magnetized in the first direction (compression direction). The crystal grains of the rare earth magnet 1 are oriented as described above, and the rare earth magnet 1 is magnetized as described above, thereby increasing the squareness ratio of the rare earth magnet 1 after magnetization.

As shown in FIG. 1, the rare earth magnet 1 is an aggregate of the insulated magnetic granular materials 2 each having the insulating layer 4 on the surface layer thereof. The rare earth magnet 1 includes the plurality of insulated magnetic granular materials 2 that are electrically isolated from each other by the insulating layers 4, thereby having a high electrical resistivity. This reduces the eddy current loss of the rare earth magnet 1. Accordingly, the rare earth magnet 1 has a suitable squareness ratio and reduced eddy current loss.

### Manufacturing Method of the Rare Earth Magnet 1

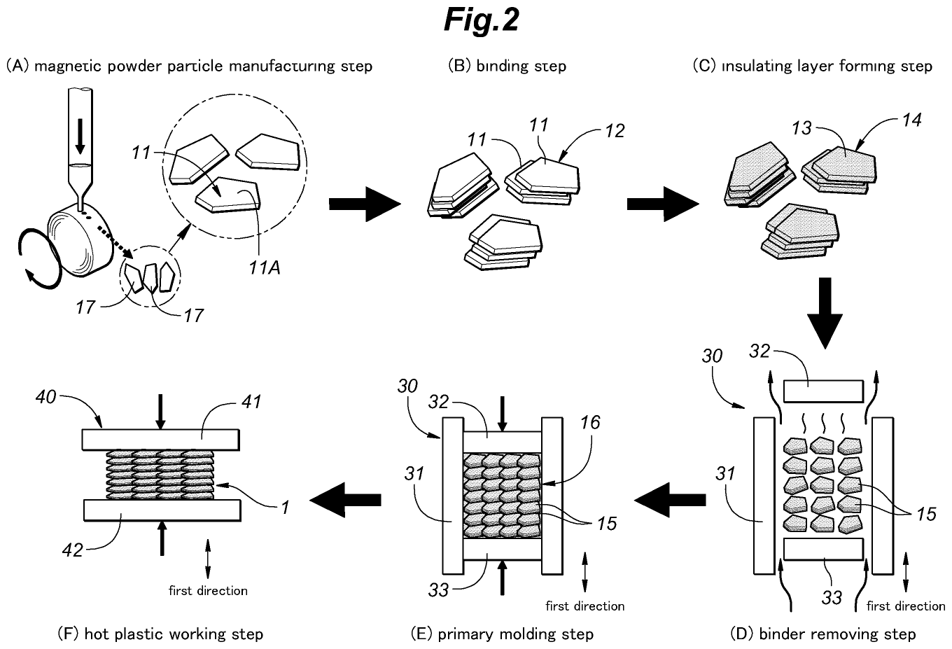

FIG. 2 is a diagram showing the manufacturing method of the rare earth magnet 1. As shown in FIG. 2, the manufacturing method of the rare earth magnet 1 includes a magnetic powder particle manufacturing step (A) of manufacturing the rare earth magnetic powder particles 11; a binding step (B) of binding the rare earth magnetic powder particles 11 so as to be laminated to obtain a magnetic granular material precursor 12; an insulating layer forming step (C) of forming an insulating layer 13 on a surface of each of the magnetic granular material precursor 12 to obtain insulated magnetic granular materials 14; a binder removing step (D) of removing the binder compound contained in the insulated magnetic granular materials 14 by thermal decomposition to obtain degreased magnetic granular materials 15; the primary molding step (E) of obtaining a primary molded product 16 by primary molding the degreased magnetic granular materials 15; and a hot plastic working step (F) of performing hot plastic working on the primary molded product 16 to obtain the rare earth magnet 1.

The magnetic powder particle manufacturing step (A) is a step for manufacturing the flake-shaped rare earth magnetic powder particles 11 having a predetermined size. A melt spinning technique is preferably used in the magnetic powder particle manufacturing step (A). As shown in step (A) of FIG. 2, the melt spinning technique is a technique of obtaining a thin plate-shaped magnet by spraying a rare earth magnet heated to a molten state onto a roll and cooling the sprayed rare earth magnet. The composition of the rare earth magnet to be melted is the same as the composition of the rare earth magnetic powder particle 3. The thin plate-shaped magnet is then pulverized to obtain small magnet pieces 17. Then, the rare earth magnetic powder particles 11 are obtained by classifying the rare earth magnetic powder particles 11 from the small magnet pieces 17. It should be noted that the melt spinning technique does not necessarily have to be used in the magnetic powder particle manufacturing step (A). The magnetic powder particle manufacturing step (A) may be a step of pulverizing a thin plate-shaped rare earth magnet to obtain the rare earth magnetic powder particles 11.

The rare earth magnetic powder particle 11 is preferably a flake-shaped neodymium magnet (Nd—Fe—B magnet, more precisely, Nd₂Fe₁₄B). Anisotropy refers to a property in which crystal orientations (easy magnetization axes, c-axes) are aligned in a specific direction. Isotropy refers to a property in which crystal orientations are not aligned in a specific direction.

The rare earth magnetic powder particle 11 becomes more likely to crack as the thickness decreases. The lower limit of the major-axis length of the rare earth magnetic powder particle 11 is 300 μm, and the average thickness of the rare earth magnetic powder particles 11 is preferably 10 μm to 30 μm. Further, the average thickness of the rare earth magnetic powder particles 11 is preferably 20 μm.

The rare earth magnetic powder particle 11 has a flake shape and includes a pair of main surfaces 11A. The main surfaces 11A are the largest pair of surfaces among a pair of flat surfaces facing opposite directions. The rare earth magnetic powder particle 11 may have an aspect ratio of approximately 1 (for example, 0.7 to 1.0) when viewed from a direction perpendicular to the main surfaces 11A. The aspect ratio is the ratio of the minor diameter b (minor-axis length) to a major diameter a (major-axis length) of a particle (aspect ratio=minor diameter b/major diameter a). Here, the major diameter a (major-axis length) means a maximum Feret diameter, and the minor diameter b (minor-axis length) means a minimum Feret diameter. The method for measuring the major diameter and the minor diameter complies with the provisions of JIS Z8890:2017 “Particle characterization of particulate systems.”

The binding step (B) is a step of binding the plurality of rare earth magnetic powder particles 11 so as to be laminated by the binder compound to obtain the magnetic granular material precursor 12. In the binding step (B), the binder compound solution may be sprayed onto the rare earth magnetic powder particles 11 that are being tumbled and fluidized using a tumbling fluidized bed apparatus 20 (see FIG. 3), and the plurality of rare earth magnetic powder particles 11 is bound so as to be laminated by the binder compound.

The binder compound solution is, for example, a solution containing 4 wt % of the binder compound. The binder compound is preferably an acrylic polymer having a weight average molecular weight greater than 100,000 and not more than 300,000, but is not limited thereto. The acrylic polymer is thermally decomposable at a temperature lower than the melting point of the rare earth magnetic powder particles 11.

The binder compound may be any compound that can bind the rare earth magnetic powder particles 11. The binder compound does not necessarily have a weight average molecular weight greater than 100,000 and not more than 300,000. The binder compound is preferably, in one embodiment, an acrylic polymer. The binder compound is preferably a resin. Further, in the manufacturing method according to the present invention, the binder compound has a thermal decomposability such that the binder compound thermally decomposes at a temperature lower than the melting point of the rare earth magnetic powder particles 11.

The solvent of the binder compound solution is preferably 2-propanol (also referred to as “isopropyl alcohol” or “IPA”), but is not limited thereto. The solvent of the binder compound solution is preferably alcohol. To allow the solvent to be readily evaporated after the rare earth magnetic powder particles 11 are bound so as to be laminated, the solvent of the binder compound solution is preferably a solvent that readily evaporates at room temperature.

FIG. 3 is a schematic diagram of the tumbling fluidized bed apparatus 20. As shown in FIG. 3, the tumbling fluidized bed apparatus 20 includes a body housing 22 having a fluidized bed 21 therein for tumbling and fluidizing the rare earth magnetic powder particles 11, a rotatable blade rotor 23 that defines the bottom of the fluidized bed 21, a spray nozzle 24 provided on the side of the body housing 22, and an air blower (not shown) that transmits a swirling air flow to the fluidized bed 21 through a gap between the outer circumference of the blade rotor 23 and the body housing 22. The blade rotor 23 includes a conical portion 23A that protrudes upward at a central portion thereof, and stirring blades 23B that protrude upward and extend radially. The spray nozzle 24 is attached to the body housing 22 to spray the binder compound solution toward the lower portion of the fluidized bed 21.

In the binding step (B), the rare earth magnetic powder particles 11 are introduced into the fluidized bed 21. The blade rotor 23 is then rotated, and the air blower generates a swirling air flow within the fluidized bed 21. As a result, the rare earth magnetic powder particles 11 in the fluidized bed 21 are tumbled and fluidized. In this state, the binder compound solution is sprayed from the spray nozzle 24 onto the rare earth magnetic powder particles 11 that are being tumbled and fluidized. Here, to properly bind the rare earth magnetic powder particles 11, the binder compound solution is preferably sprayed at a rate of not less than 5 g/min and not more than 30 g/min per 1 kg of the rare earth magnetic powder particles 11 that are being tumbled and fluidized.

The rare earth magnetic powder particles 11 are bound by the sprayed binder compound solution. Here, the binder compound solution binds the main surfaces 11A of the adjacent rare earth magnetic powder particles 11. The solvent (IPA) evaporates from the binder compound solution that binds the rare earth magnetic powder particles 11. Accordingly, the magnetic granular material precursor 12 is obtained in which a plurality of rare earth magnetic powder particles 11 are bound so as to be laminated by the binder compound. Here, the phrase “being bound so as to be laminated” means that a plurality of rare earth magnetic powder particles 11 are bound with the main surfaces 11A thereof facing in the same direction. The magnetic granular material precursor 12 includes the laminated flake-shaped rare earth magnetic powder particles 11. The term “laminated flake-shaped rare earth magnetic powder particles 11” means a plurality of rare earth magnetic powder particles 11 laminated with the main surfaces 11A thereof facing in the same direction.

In the magnetic granular material precursor 12, the binder compound solution that binds the rare earth magnetic powder particles 11 is dried. The magnetic granular material precursor 12 preferably contains 0.5 to 2.5 wt % of the binder compound. The concentration of the binder compound in the binder compound solution and the injection amount of the binder compound solution are set so that the magnetic granular material precursor 12 contains 0.5 to 2.5 wt % of the binder compound. To ensure that the rare earth magnet 1 manufactured from the magnetic granular material precursor 12 has favorable magnetic properties, the thickness of the magnetic granular material precursor 12 in a lamination direction of the rare earth magnetic powder particles 11 is preferably 0.15 mm or more and 1 mm or less.

As shown in FIG. 2, the insulating layer forming step (C) is a step of forming the insulating layer 13 having insulating properties on the surface layer of each of the magnetic granular material precursors 12 to obtain the magnetic granular materials 14. The magnetic granular material 14 is a powder particle obtained by forming the insulating layer 13 on the magnetic granular material precursor 12. In the insulating layer forming step (C), using the tumbling fluidized bed apparatus 20, a nanoparticle dispersion liquid containing the plurality of fluoride nanoparticles 4A is sprayed onto the magnetic granular material precursors 12 that are being tumbled and fluidized, thereby forming the insulating layer 13 on the surface layer of the magnetic granular material precursors 12.

As described above, the fluoride nanoparticles 4A are nanoparticles made of calcium fluoride (CaF₂) and preferably have a particle diameter of 1 to 100 nm. The fluoride nanoparticles 4A may be particles made of an inorganic fluorine compound having insulating properties. The fluoride nanoparticles 4A preferably have a melting point higher than that of the rare earth magnetic powder particle 11 and exhibit low reactivity with the rare earth magnetic powder particles 11. The fluoride nanoparticles 4A are preferably nanoparticles made of an alkali metal fluoride such as lithium fluoride, or nanoparticles made of an alkaline earth metal fluoride such as magnesium fluoride, barium fluoride, or strontium fluoride. The insulating layer 13 may include, as the fluoride nanoparticles 4A, a plurality of nanoparticles made of an alkali metal fluoride and a plurality of nanoparticles made of an alkaline earth metal fluoride. The insulating layer 13 may also include, as the fluoride nanoparticles 4A, nanoparticles containing an alkali metal fluoride and an alkaline earth metal fluoride.

The nanoparticle dispersion liquid contains, for example, 4 wt % of the fluoride nanoparticles 4A and 2.5 wt % of the binder compound. Accordingly, the insulating layer 13 formed by drying the nanoparticle dispersion liquid contains 38 wt % of the binder compound and 62 wt % of the fluoride nanoparticles 4A.

The solvent of the nanoparticle dispersion liquid is preferably 2-propanol (IPA). The binder compound is a compound capable of binding the fluoride nanoparticles 4A, and is preferably the same compound as the binder compound used in the binding step (B). The fluoride nanoparticles 4A are dispersed in the nanoparticle dispersion liquid. The concentrations of the fluoride nanoparticles 4A and the binder compound in the nanoparticle dispersion liquid, as well as the solvent, may be changed.

In the insulating layer forming step (C), as shown in FIG. 3, the magnetic granular material precursors 12 are introduced into the fluidized bed 21 of the tumbling fluidized bed apparatus 20. The blade rotor 23 is then rotated, and the air blower generates a swirling air flow within the fluidized bed 21. As a result, the magnetic granular material precursors 12 in the fluidized bed 21 are tumbled and fluidized. In this state, the nanoparticle dispersion liquid is sprayed from the spray nozzle 24 onto the magnetic granular material precursors 12 that are being tumbled and fluidized. The sprayed nanoparticle dispersion liquid adheres to the surfaces of the magnetic granular material precursors 12 and is dried. Accordingly, the insulating layer 13 is formed on the surface layers of the magnetic granular material precursors 12, and the magnetic granular materials 14 are obtained.

The insulating layer 13 formed as described above preferably contains the plurality of fluoride nanoparticles 4A made of a fluoride and having a particle diameter of 1 to 100 nm, and is formed to contain 20 wt % or more of the binder compound that binds the plurality of fluoride nanoparticles 4A.

The binder removing step (D) is a step of heating the magnetic granular materials 14 to a temperature equal to or higher than the thermal decomposition temperature of the binder compound to thermally decompose the binder compound, thereby obtaining the degreased magnetic granular materials 15 from which the binder compound has been removed.

In the binder removing step (D), the magnetic granular materials 14 may be heated within the mold of a hot press machine. As shown in step (D) of FIG. 2, a mold 30 of the hot press machine includes a cylindrical mold body 31, and an upper mold 32 and a lower mold 33 capable of applying a compressive force in a first direction to an object within the mold body 31. In FIG. 2, the first direction is the up-and-down direction, but the first direction may be a direction other than the up-and-down direction.

In the binder removing step (D), the magnetic granular materials 14 arranged within the mold body 31 of the mold 30 are heated, without pressure being applied by the mold 30 (the upper mold 32 and the lower mold 33), to a temperature equal to or higher than the thermal decomposition temperature of the binder compound (for example, 300° C. to 400° C.) for the predetermined period (for example, 2 to 4 hours) in a reduced pressure environment or in an inert gas flow. The inert gas is a gas having low reactivity with the rare earth magnetic powder particles 11. The inert gas is preferably, for example, a noble gas. The inert gas is preferably helium gas. Air may be used when oxidation is not a concern or under controlled conditions.

The products generated by thermal decomposition of the binder compound are discharged to the outside of the mold 30. The binder compound is preferably an acrylic polymer (polymethyl methacrylate) having a weight average molecular weight greater than 100,000 and not more than 300,000. The acrylic polymer is thermally decomposed into the methyl methacrylate monomer. The decomposition products generated by the thermal decomposition of the binder compound volatilize and are discharged to the outside of the mold 30.

When the magnetic granular materials 14 are heated in the reduced pressure environment in the binder removing step (D), the magnetic granular materials 14 are heated within the mold body 31 (the mold 30) in the reduced pressure environment. In this case, the decomposition products of the binder compound (for example, the methyl methacrylate monomer) are more likely to volatilize since the decomposition products are arranged in the reduced pressure environment, and are more readily discharged to the outside of the mold body 31 (the mold 30). Further, the decomposition products of the binder compound are less likely to remain around the magnetic granular materials 14 and less likely to react with the rare earth magnetic powder particles 11, thereby contributing to suppression of deterioration of the rare earth magnetic powder particles 11.

When the magnetic granular materials 14 are heated in an inert gas flow, the magnetic granular materials 14 are heated while the inert gas is flowing inside the mold body 31 (the mold 30). This allows the decomposition products of the binder compound (for example, the methyl methacrylate monomer) to be readily discharged to the outside of the mold body 31 (the mold 30) by the inert gas flow. Further, the decomposition products of the binder compound are less likely to remain around the magnetic granular materials 14 and less likely to react with the rare earth magnetic powder particle 11, thereby contributing to suppression of deterioration of the rare earth magnetic powder particle 11. It is preferable that the inert gas be heated to a temperature equal to or higher than the thermal decomposition temperature of the binder compound before the inert gas is introduced into the mold 30. This allows the binder compound to be heated by the inert gas, thereby promoting the thermal decomposition of the binder compound.

The primary molding step (E) is a step of obtaining the primary molded product 16 by applying pressure to the degreased magnetic granular materials 15. The mold 30 may be used in the primary molding step (E). The primary molding step (E) is a step of obtaining the primary molded product 16 by primary molding the degreased magnetic granular materials 15 obtained by removing the binder compound from the magnetic granular materials 14. The primary molding step (E) may be considered as a type of step in which the plurality of magnetic granular materials 14 obtained in the insulating layer forming step (C) are primarily molded to obtain the primary molded product 16 in which the plurality of magnetic granular materials 14 is primarily molded.

The primary molding step (E) may be a step of performing hot forming (primary molding) in which the degreased magnetic granular materials 15 are heated to the predetermined temperature within the mold 30, and the predetermined pressure is applied for the predetermined period. Here, hot forming may be performed at a mold temperature of 600° C. to 700° C., preferably about 640° C. When pressure is applied to the degreased magnetic granular materials 15 within the mold 30, the plurality of degreased magnetic granular materials 15 is oriented so that the main surfaces 11A of the rare earth magnetic powder particles 11 contained in the degreased magnetic granular materials 15 face the first direction, and are laminated in a direction (the first direction) perpendicular to the main surfaces 11A. Accordingly, by hot forming, the plurality of degreased magnetic granular materials 15 is compressed and deformed while being laminated in a direction (the first direction) perpendicular to the main surfaces of the degreased magnetic granular materials 15 (the main surfaces 11A of the rare earth magnetic powder particles 11).

The hot plastic working step (F) is a step of performing hot plastic working on the primary molded product 16 obtained in the primary molding step (E) to obtain the rare earth magnet 1. Since the primary molded product 16 includes the plurality of degreased magnetic granular materials 15, the hot plastic working step (F) can be regarded as a step of performing hot plastic working on the degreased magnetic granular materials 15 obtained in the binder removing step (D) to obtain the rare earth magnet 1. The hot plastic working step (F) includes heating the primary molded product 16, while pressure is being applied thereto, to a temperature at which a part of the crystal grains of the rare earth magnetic powder particle 11 undergoes a phase transition to a liquid phase (melting point of the rare earth magnetic powder particle 11, for example, about 850° C.), thereby plastically deforming the primary molded product 16.

The hot plastic working step (F) is performed using a second mold 40. The second mold 40 has an upper pressing die 41 and a lower pressing die 42 arranged opposite to each other. The primary molded product 16 is arranged within the second mold 40 such that pressure is applied to the plurality of degreased magnetic granular materials 15 contained in the primary molded product 16 in a direction (first direction) perpendicular to the main surfaces 11A. During plastic deformation of the primary molded product 16, the crystal grains of the rare earth magnetic powder particles 11 contained in the primary molded product 16 are oriented such that a c-axis direction (an easy magnetization direction) of the crystal grains is parallel to the first direction (the compression direction). Accordingly, magnetic anisotropy (uniaxial anisotropy) is developed in the primary molded product 16 during the plastic deformation. The rare earth magnetic powder particles 3 contained in the rare earth magnet 1 are obtained by plastically deforming the rare earth magnetic powder particles 11 such that the crystal grains are oriented in the first direction (the compression direction). The rare earth magnet 1 obtained in the hot plastic working step (see FIG. 1) is magnetized in the direction (first direction) in which the magnetic anisotropy is developed.

In the hot plastic working step (F), the degreased magnetic granular materials 15 are heated, while pressure is being applied thereto in a direction (first direction) perpendicular to the main surfaces of the degreased magnetic granular materials 15. Accordingly, the crystal grains in the magnet are shortened in the first direction (the compression direction) and elongated in a direction perpendicular to the first direction (the direction in which the main surface extends). The rare earth magnet 1 is magnetized in the first direction (the compression direction). The rare earth magnet 1 includes the plurality of laminated flake-shaped rare earth magnetic powder particles 3, the crystal grains of the rare earth magnet 1 are oriented as described above, and the rare earth magnet 1 is magnetized as described above, thereby increasing the squareness ratio of the rare earth magnet 1.

As shown in FIG. 1, the rare earth magnet 1 is an aggregate of the insulated magnetic granular materials 2 each having the insulating layer 4 on the surface layer thereof, and has high electrical resistivity due to the insulating layer 4. This reduces the eddy current loss of the rare earth magnet 1. Accordingly, the rare earth magnet 1 has a suitable squareness ratio and reduced eddy current loss.

Next, the effects of the rare earth magnet 1 manufactured in this manner and the manufacturing method thereof will be described.

The manufacturing method of the rare earth magnet 1 includes the binder removing step (D) of thermally decomposing the binder compound to obtain the degreased magnetic granular materials 15 by removing the binder compound from the magnetic granular materials 14, and the hot plastic working step (F) of performing hot plastic working on the degreased magnetic granular materials 15 obtained in the binder removing step (D) to obtain the rare earth magnet 1. The binder compound has a thermal decomposition temperature lower than the melting point of the rare earth magnetic powder particles, and is thermally decomposable at a temperature equal to or higher than the thermal decomposition temperature.

In the binder removing step (D), the binder compound is removed from the magnetic granular materials 14, thereby reducing the volume of the insulating layer 13. In the manufacturing method of the rare earth magnet 1, the binder compound is removed before the hot plastic working step (F). Accordingly, during the hot plastic working step (F), deterioration of magnetic properties, such as residual magnetic flux density, including the following (1) and (2), caused by thermal decomposition of the binder compound can be suppressed.
(1) Deterioration of magnetic properties caused by reaction between the decomposition products of the binder compound (for example, the methyl methacrylate monomer) and the rare earth magnetic powder particles 11.
(2) Deterioration of magnetic properties caused by a decrease in density of the rare earth magnet due to formation of voids in space where the binder compound was present.
   Accordingly, the rare earth magnet 1 having favorable magnetic properties can be manufactured from the magnetic granular material 14.

After the binder compound is removed in the binder removing step (D), the primary molding step (E) is performed, and then the hot plastic working step (F) is performed. Here, since the binder compound is removed before the primary molding step (E), during the primary molding step (E), deformation of the primary molded product 16 due to thermal decomposition of the binder compound is suppressed. Further, the shape of the rare earth magnet 1 is determined by the primary molding step (E) and the hot plastic working step (F), and the crystal grains are oriented such that the c-axis direction (the easy magnetization direction) of the crystal grains is oriented parallel to the first direction (the compression direction). Accordingly, it is possible to suppress the deformation of the rare earth magnet 1 due to thermal decomposition of the binder compound.

Further, compared with the primary molded product 16 in which the magnetic granular materials 14 are laminated, the magnetic granular material 14 before the primary molding step (E), which is not laminated, has better air permeability. In the binder removing step (D), since the binder compound is thermally decomposed and removed while the magnetic granular materials 14 are in a state in which good air permeability is ensured, the binder compound can be removed rapidly and reliably.

In the binder removing step (D), the magnetic granular material 14 is heated, without pressure being applied thereto, to a temperature equal to or higher than the thermal decomposition temperature in the reduced pressure environment.

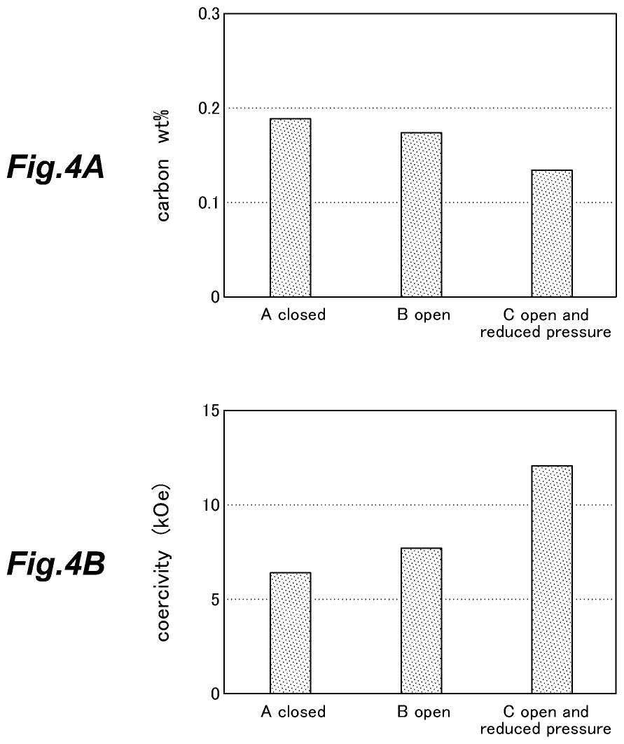

FIGS. 4A and 4B are graphs showing the differences in properties of the rare earth magnet 1 depending on the heating method of the magnetic granular material 14 in the binder removing step (D). FIG. 4A is a graph showing the difference in the carbon concentration of the rare earth magnet 1 depending on the heating method of the magnetic granular material 14 in the binder removing step (D). FIG. 4B is a graph showing the difference in the coercivity iHC of the rare earth magnet 1 depending on the heating method of the magnetic granular material 14 in the binder removing step (D).

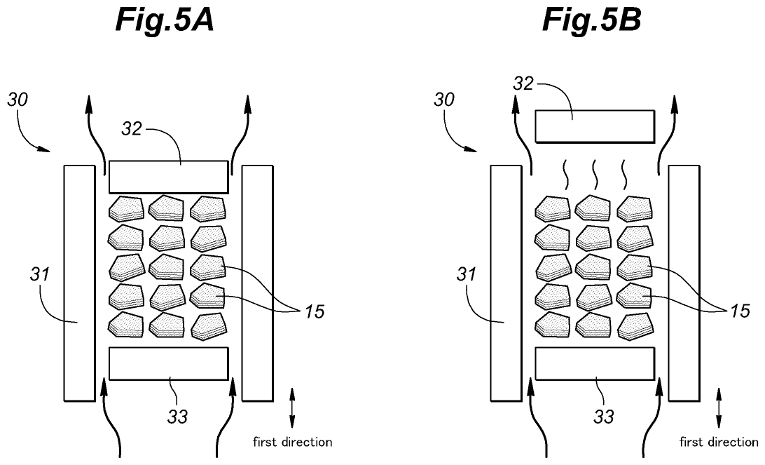

FIGS. 5A and 5B are schematic diagrams showing a state in which the magnetic granular materials 14 are being heated. FIG. 5A is a schematic diagram showing a state in which the magnetic granular materials 14 are heated, without pressure being applied thereto, in a space closed by the mold body 31, the upper mold 32, and the lower mold 33 of the mold 30. FIG. 5B is a schematic diagram showing a state in which the magnetic granular materials 14 are heated, without pressure being applied thereto, in an open space within the mold 30.

In FIGS. 4A and 4B, “A”, “B”, and “C” represent the following.
“A” represents the rare earth magnet manufactured by removing the binder compound by heating the magnetic granular materials 14 in the closed space within the mold 30 in the binder removing step (D) (see FIG. 5A), and then performing the primary molding step (E) and the hot plastic working step (F).
“B” represents the rare earth magnet manufactured by removing the binder compound by heating the magnetic granular materials 14 in the open space within the mold 30 in the binder removing step (D) (see FIG. 5B), and then performing the primary molding step (E) and the hot plastic working step (F).
“C” represents the rare earth magnet manufactured by removing the binder compound by heating the magnetic granular materials 14 in the open space within the mold 30 in the reduced pressure environment in the binder removing step (D) (see FIG. 5B), and then performing the primary molding step (E) and the hot plastic working step (F).

As shown in FIG. 4A, the carbon concentration in the illustrated example satisfies the relationship A>B>C. The carbon contained in the rare earth magnet is considered to originate from the binder compound that has not been thermally decomposed in the rare earth magnet. Accordingly, the lower the carbon content in the rare earth magnet, the smaller the amount of binder compound that remains undecomposed in the rare earth magnet. Therefore, the susceptibility of the binder compound to thermal decomposition satisfies the following relationship: heating the magnetic granular materials 14 in a closed space (A)<heating the magnetic granular materials 14 in an open space (B)<heating the magnetic granular materials 14 in an open space in the reduced pressure environment (C).

As shown in FIG. 4B, the coercivity satisfies the relationship A<B<C. The smaller the amount of the binder compound that remains undecomposed in the rare earth magnet, the higher the coercivity of the rare earth magnet. Therefore, the coercivity of the rare earth magnet satisfies the following relationship: heating the magnetic granular materials 14 in a closed space (A)<heating the magnetic granular materials 14 in an open space (B)<heating the magnetic granular materials 14 in an open space in the reduced pressure environment (C).

As described above, FIGS. 4A and 4B show that, in the binder removing step, by heating the magnetic granular materials 14, without pressure being applied thereto, to a temperature equal to or higher than the thermal decomposition temperature in a reduced pressure environment, it is possible to reduce the amount of undecomposed binder compound remaining in the rare earth magnet 1 manufactured from the magnetic granular materials 14 and to improve the coercivity of the rare earth magnet 1. Therefore, in the binder removing step, the magnetic granular materials 14 are heated, without pressure being applied thereto, to a temperature equal to or higher than the thermal decomposition temperature in a reduced pressure environment, thereby reducing the amount of undecomposed binder compound remaining in the rare earth magnet 1 manufactured from the magnetic granular materials 14 and improving the coercivity of the rare earth magnet 1 manufactured from the magnetic granular materials 14.

In the binder removing step (D), the magnetic granular materials 14 are heated, without pressure being applied thereto, to a temperature equal to or higher than the thermal decomposition temperature in an inert gas flow. Accordingly, the binder compound of the magnetic granular materials 14 can be thermally decomposed more rapidly and removed reliably. Accordingly, the amount of undecomposed binder compound remaining in the rare earth magnet 1 manufactured from the magnetic granular material 14 can be reduced.

In the binder removing step (D), the magnetic granular material 14 is heated, without pressure being applied thereto, to a temperature equal to or higher than the thermal decomposition temperature in an inert gas flow having a temperature equal to or higher than the thermal decomposition temperature. The inert gas flow promotes the thermal decomposition of the binder compound, so that the binder compound of the magnetic granular materials 14 can be thermally decomposed more rapidly and removed reliably.

The magnetic granular material 14 includes the insulating layer 13 formed on the surface layer. This facilitates the manufacture of the rare earth magnet 1 having a relatively high electrical resistivity using the magnetic granular materials 14.

The binder compound contained in the insulating layer 13 has a weight average molecular weight of 100,000 or more and 300,000 or less. As the weight average molecular weight of the binder compound increases, the adhesion increases, and the binder compound becomes less soluble in the solvent. When the binder compound has a weight average molecular weight of 100,000 or more and 300,000 or less, the adhesion of the binder compound becomes sufficiently high, and the binder compound becomes sufficiently soluble in the solvent. Accordingly, the insulating layer 13 suitable for the magnetic granular material 14 can be formed. Accordingly, the electrical resistivity of the rare earth magnet 1 manufactured from the magnetic granular materials 14 can be reliably increased, and the eddy current loss of the rare earth magnet 1 can be reliably reduced.

The binder compound is an acrylic polymer. This makes it easier to thermally decompose and remove the binder compound during the manufacturing process of the rare earth magnet 1 from the magnetic granular materials 14, and to reduce the amount of undecomposed binder compound remaining in the rare earth magnet 1.

This concludes the description of the specific embodiment, but the present invention is not limited to the above embodiment and can be widely modified and implemented. For example, the solvent of the binder compound solution and the nanoparticle dispersion liquid is not limited to IPA, and may be an alcohol that is liquid at room temperature, such as 1-propanol or butanol.

The above embodiment may also be described as follows.

One embodiment is a manufacturing method of a rare earth magnet 1 from a plurality of magnetic granular materials 14, each of the plurality of magnetic granular materials 14 including a plurality of laminated flake-shaped rare earth magnetic powder particles 11 and a binder compound that binds the plurality of rare earth magnetic powder particles 11. The binder compound has a thermal decomposition temperature lower than the melting point of the plurality of rare earth magnetic powder particles 11, and is thermally decomposable at a temperature equal to or higher than the thermal decomposition temperature. The manufacturing method includes: a binder removing step (D) of heating the plurality of magnetic granular materials 14 to a temperature equal to or higher than the thermal decomposition temperature to thermally decompose the binder compound, thereby obtaining a plurality of degreased magnetic granular materials 15 by removing the binder compound from the plurality of magnetic granular materials 14; and a hot plastic working step (F) of performing hot plastic working on the plurality of degreased magnetic granular materials 15 obtained in the binder removing step (D) to obtain the rare earth magnet 1.

According to this aspect, during the hot plastic working step (F), deterioration of the magnetic properties, such as residual magnetic flux density, including the following (1) and (2), caused by thermal decomposition of the binder compound can be suppressed.
(1) Deterioration of magnetic properties caused by reaction between the decomposition products of the binder compound (for example, the methyl methacrylate monomer) and the rare earth magnetic powder particles 11.
(2) Deterioration of magnetic properties caused by a decrease in density of the rare earth magnet due to formation of voids in space where the binder compound was present.
   Accordingly, the rare earth magnet 1 having favorable magnetic properties can be manufactured from the magnetic granular material 14.

In the manufacturing method of the rare earth magnet 1 in one embodiment, after the binder removing step (D) and before the hot plastic working step (F), a primary molding step is performed, the primary molding step being a step in which the plurality of degreased magnetic granular materials 15 obtained in the binder removing step (D) is arranged so as to be laminated to obtain a primary molded product 16 in which the plurality of degreased magnetic granular materials 15 is primarily molded, and the hot plastic working step (F) includes performing hot plastic working on the primary molded product 16 obtained in the primary molding step (E) to obtain the rare earth magnet 1.

According to this aspect, during the primary molding step (E), deformation of the primary molded product 16 due to thermal decomposition of the binder compound is suppressed. Accordingly, it is possible to suppress the deformation of the rare earth magnet 1 due to thermal decomposition of the binder compound. Further, since the binder compound is thermally decomposed and removed while the magnetic granular materials 14 are in a state in which good air permeability is ensured, the binder compound can be removed rapidly and reliably.

In the manufacturing method of the rare earth magnet 1 in one embodiment, in the binder removing step (D), the plurality of magnetic granular materials 14 is heated, without pressure being applied thereto, to a temperature equal to or higher than the thermal decomposition temperature in a reduced pressure environment.

According to this aspect, it is possible to reduce the amount of undecomposed binder compound remaining in the rare earth magnet 1 manufactured from the magnetic granular materials 14 and improve the coercivity of the rare earth magnet 1 manufactured from the magnetic granular materials 14.

In the manufacturing method of the rare earth magnet 1 in one embodiment, in the binder removing step (D), the plurality of magnetic granular materials 14 is heated, without pressure being applied thereto, to a temperature equal to or higher than the thermal decomposition temperature in an inert gas flow.

According to this aspect, it is possible to reduce the amount of undecomposed binder compound remaining in the rare earth magnet 1 manufactured from the magnetic granular materials 14.

In the manufacturing method of the rare earth magnet 1 in one embodiment, in the binder removing step (D), the plurality of magnetic granular materials 14 is heated, without pressure being applied thereto, to a temperature equal to or higher than the thermal decomposition temperature in the inert gas flow having the temperature equal to or higher than the thermal decomposition temperature.

According to this aspect, it is possible to reduce the amount of undecomposed binder compound remaining in the rare earth magnet 1 manufactured from the magnetic granular materials 14.

In the manufacturing method of the rare earth magnet 1 in one embodiment, each of the plurality of magnetic granular materials 14 includes an insulating layer 13 having insulating properties and provided on a surface layer.

According to this aspect, it is possible to facilitate the manufacture of the rare earth magnet 1 having a relatively high electrical resistivity using the magnetic granular materials 14.

According to this aspect, it is possible to facilitate the manufacture of the magnetic granular material 14.

In the manufacturing method of the rare earth magnet 1 in one embodiment, the binder compound has a weight average molecular weight greater than 100,000 and not more than 300,000.

According to this aspect, the insulating layer 13 suitable for the magnetic granular material 14 can be formed. Accordingly, the electrical resistivity of the rare earth magnet 1 manufactured from the magnetic granular materials 14 can be reliably increased, and the eddy current loss of the rare earth magnet 1 can be reliably reduced.

In the manufacturing method of the rare earth magnet 1 in one embodiment, the binder compound is an acrylic polymer.

According to this aspect, the binder compound can be thermally decomposed and removed during the manufacturing process of the rare earth magnet 1 from the magnetic granular materials 14, and the amount of undecomposed binder compound remaining in the rare earth magnet 1 can be reduced.

1. A manufacturing method of a rare earth magnet from a plurality of magnetic granular materials, each of the plurality of magnetic granular materials including a plurality of laminated flake-shaped rare earth magnetic powder particles and a binder compound that binds the plurality of rare earth magnetic powder particles, wherein
the binder compound has a thermal decomposition temperature lower than the melting point of the plurality of rare earth magnetic powder particles, and is thermally decomposable at a temperature equal to or higher than the thermal decomposition temperature, and
the manufacturing method includes:
a binder removing step of heating the plurality of magnetic granular materials to a temperature equal to or higher than the thermal decomposition temperature to thermally decompose the binder compound, thereby obtaining a plurality of degreased magnetic granular materials by removing the binder compound from the plurality of magnetic granular materials; and
a hot plastic working step of performing hot plastic working on the plurality of degreased magnetic granular materials obtained in the binder removing step to obtain the rare earth magnet.

2. The manufacturing method of the rare earth magnet according to claim 1, wherein,
after the binder removing step and before the hot plastic working step, a primary molding step is performed, the primary molding step being a step in which the plurality of degreased magnetic granular materials obtained in the binder removing step is primarily molded to obtain a primary molded product in which the plurality of degreased magnetic granular materials is primarily molded, and
the hot plastic working step includes performing hot plastic working on the primary molded product obtained in the primary molding step to obtain the rare earth magnet.

3. The manufacturing method of the rare earth magnet according to claim 1, wherein, in the binder removing step, the plurality of magnetic granular materials is heated, without pressure being applied thereto, to the temperature equal to or higher than the thermal decomposition temperature in a reduced pressure environment.

4. The manufacturing method of the rare earth magnet according to claim 1, wherein, in the binder removing step, the plurality of magnetic granular materials is heated, without pressure being applied thereto, to the temperature equal to or higher than the thermal decomposition temperature in an inert gas flow.

5. The manufacturing method of the rare earth magnet according to claim 4, wherein, in the binder removing step, the plurality of magnetic granular materials is heated, without pressure being applied thereto, to the temperature equal to or higher than the thermal decomposition temperature in the inert gas flow having the temperature equal to or higher than the thermal decomposition temperature.

6. The manufacturing method of the rare earth magnet according to claim 1, wherein each of the plurality of magnetic granular materials includes an insulating layer having insulating properties and provided on a surface layer.

7. The manufacturing method of the rare earth magnet according to claim 4, wherein the binder compound has a weight average molecular weight greater than 100,000 and not more than 300,000.

8. The manufacturing method of the rare earth magnet according to claim 1, wherein the binder compound is an acrylic polymer.
